(19) United States
(12) Patent Application Publication
(10) Pub. No.: US 2011/0202946 A1
(43) Pub. Date: Aug. 18, 2011

(54) Interactive Broadcast System

(75) Inventor: Andrew Jonathan Block, London (GB)

(73) Assignee: The London Television Centre, London (GB)

(21) Appl. No.: 12/708,347

(22) Filed: Feb. 18, 2010

(51) Int. Cl. H04H 60/33; H04N 5/445

(52) U.S. Cl. 725/13; 348/563; 725/32; 348/E05.099

(57) ABSTRACT

A method of displaying customised media content wherein the viewer can affect the media content displayed by giving answers to a question displayed with the media content is provided. For example, a method of displaying customised media content, comprising receiving video data, including an advertisement, at an output device; displaying the advertisement on the output device; receiving interactive data, including a question, a correct answer to the question and at least one incorrect answer to the question, at the output device; displaying the question, the correct answer and the incorrect answer on the output device; receiving an indication of a user's answer to the question at the output device; and displaying further visual content on the output device based on the answer.

### FIELD OF THE INVENTION

This invention relates to an interactive broadcast system and methods of implementation of such a system. In particular, systems and methods are provided to allow user-direction of advertisements in interactive broadcast systems.

### BACKGROUND OF THE INVENTION

On-demand and interactive broadcast systems provide users with the ability to interact with, and define, the content they receive through a broadcast channel. Many types of interactive broadcast channel are available, including cable, satellite, and internet-based services. Internet-based services are particularly versatile in the range of interactive options that can be provided, and may allow complete user control over the content viewed. For example, the service may allow the user to skip sections of the broadcast such that they only view the sections of interest. This is also possible, although often not with comparable versatility, via other broadcast channels.

Providing users with increased ability to move through a broadcast also brings disadvantages to the content provider. One of the key sections of a broadcast that a user may wish to skip is advertising. However, if users skip advertising sections the value of advertising is diminished, thereby reducing the content provider's income.

There is therefore a requirement for a broadcast system that allows users to be offered increased interaction possibilities, but that does not disadvantage the content provider.

### SUMMARY OF THE INVENTION

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

Embodiments of the present invention provide a method of displaying customised media content, comprising receiving video data, including an advertisement, at an output device; displaying the advertisement on the output device; receiving interactive data, including a question, a correct answer to the question and at least one incorrect answer to the question, at the output device; displaying the question, the correct answer and the incorrect answer on the output device; receiving an indication of a user's answer to the question at the output device; and displaying further visual content on the output device based on the answer.

There is also provided a method of transmitting customisable media content to an output device, comprising streaming video data, including an advertisement, to an output device; transmitting, to the output device, interactive data including a question, a correct answer to the question and at least one incorrect answer to the question; receiving, from the output device, a request to terminate streaming of the video data before the end of the video data, and receiving, from the output device, a request to stream different video data to the output device.

The video data may be a streamed video received from a video content server over a network.

The user's answer may be incorrect in which case the further visual content is the remainder of the video.

The user's answer may be correct in which case the further visual content is visual content requested by the user which is output earlier than would have occurred if the user's answer had been incorrect.

The indication of the user's answer may be received by the output device and transmitted to a remote device for determination of its correctness.

The video and/or interactive data may be transmitted to the output device as a self-contained file for later playback at the output device.

The user's answer may be transmitted to a remote device for monitoring of answers provided by users.

The request to terminate streaming of the video data may be received from the output device in response to a user of the output device indicating a correct answer to the question.

The interactive section may be displayed concurrently with the advertisement.

The interactive section may be displayed alongside the advertisement.

The interactive section may be displayed over at least a portion of the advertisement.

The advertisement may be displayed for a predetermined period of time before the interactive section is displayed.

The method may further comprise receiving video data, including visual content requested by the output device, at the output device; and displaying the visual content on the output device for a predetermined period of time before displaying the advertisement on the output device.

The preferred features may be combined as appropriate, as would be apparent to a skilled person, and may be combined with any of the aspects of the invention.

### BRIEF DESCRIPTION OF THE DRAWINGS

Embodiments of the invention will be described, by way of example, with reference to the following drawings, in which:

FIG. 1 shows a schematic overview of an interactive broadcast system according to an embodiment of the present invention,

FIG. 2 shows a flow chart of a method of interactive media broadcast according to an embodiment of the present invention,

FIG. 3 shows an interaction diagram for a process according to an embodiment of the present invention, and

FIG. 4 shows a block diagram of a computing-based device according to an embodiment of the present invention.

### DETAILED DESCRIPTION

Embodiments of the present invention are described below by way of example only. These examples represent the best ways of putting the invention into practice that are currently known to the Applicant although they are not the only ways in which this could be achieved. The description sets forth the functions of the example and the sequence of steps for constructing and operating the example. However, the same or equivalent functions and sequences may be accomplished by different examples.

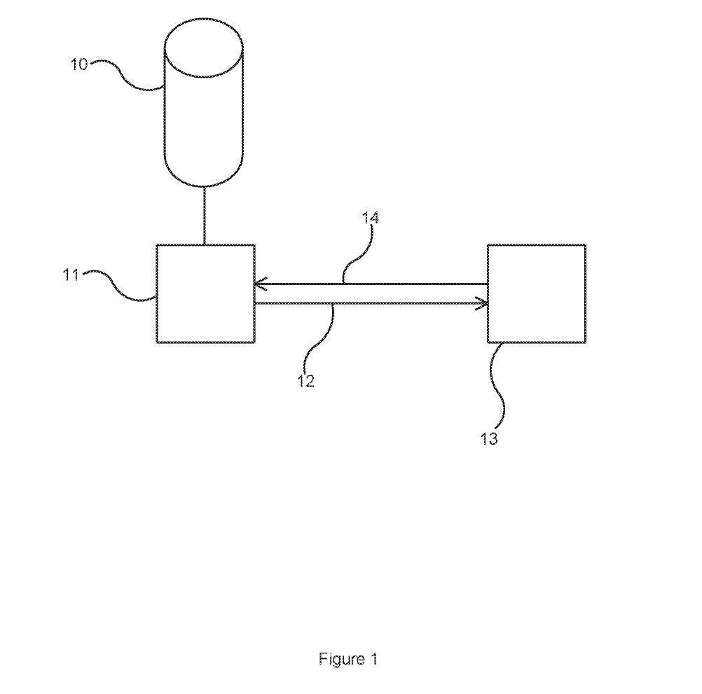

FIG. 1 shows a schematic overview of an interactive broadcast system. A repository of media for broadcast is stored in storage system 10, for example a data centre for storing media in digital form. Storage system 10 is connected to broadcast device 11 which is connected via a broadcast channel 12 to user output device 13. The broadcast channel 12 may, for example, be a computer network such as the internet and output device 13 may be a computer. Broadcast device 11 retrieves media from the storage system and transmits it over the broadcast channel 12 to the output device 13 for viewing by users. A communications channel 14 is provided for the transmission of data, for example control instructions from, the output device 13 to the broadcast device 11. The communications channel 14 enables users to control the media transmitted by the broadcast device 11. The communications channel 14 may be a bi-directional channel and may be utilised to transmit data from the broadcast device 11 to the output devices 13. The communications channel 14 may be provided by the same medium as the broadcast channel 12, or a different medium. For example, both channels may be the internet, or the broadcast channel 12 may be a satellite channel and the communications channel 14 may be a telephone line connection. For clarity only, a single output device is shown, but multiple devices are contemplated. Similarly, only a single broadcast device is shown, but multiple devices may be utilised, each co-located or located separately, and each serving different sections of data to the output device.

The term “broadcast” is used in a broad sense and includes both one-to-many broadcast systems (for example a satellite system), and also one-to-one broadcast systems (for example internet-based systems). The term is not intended to restrict this disclosure to any particular distribution mechanism and is used only as a convenient term to encompass all possible methods for distribution.

The communications channel 14 allows users to control the media they receive, for example by speeding up or skipping sections. As discussed previously, although this provides an improved user experience, it also presents the problem of reducing the value of advertising or other income sources for the broadcaster. The scope of a user's control may be limited to prevent, for example, skipping over advertisement breaks, thereby improving the exposure of advertisements. However, this can lead to customer annoyance as they are forced to view media they would prefer not to.

The output device 13 is dependent on the broadcast system and may for example be a decoder system, or a computing device. The output device has systems for receiving the data and displaying the media represented by the data.

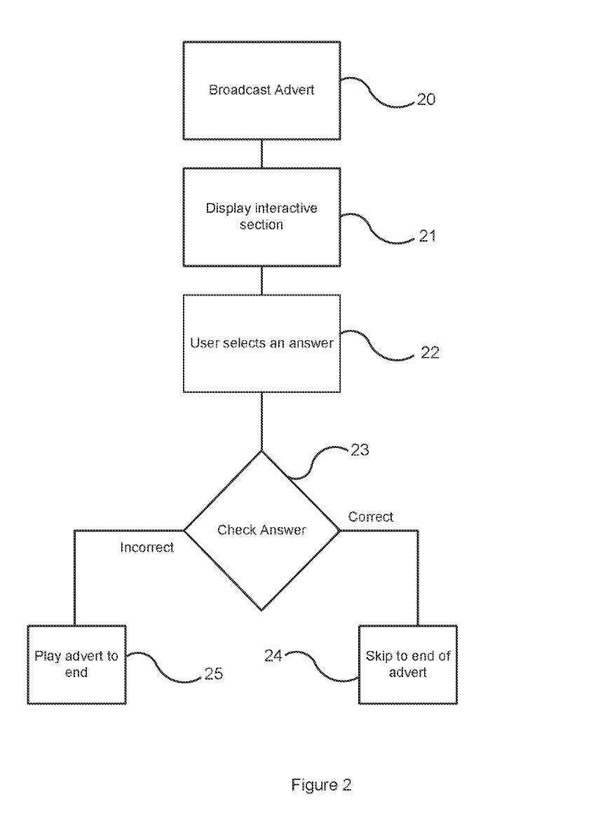

FIG. 2 shows a flow chart of a method of enabling user interaction with broadcast media while maintaining value in that media.

At step 20 an advertisement is broadcast by broadcast device 11 to an output device 13 for display on that output device. The advertisement may be broadcast before the start of a program requested by the user of the output device, or as a break during the transmission of that program. After an initial period of the advertisement has been broadcast or displayed, at step 21 an interactive section is broadcast and displayed alongside or over a portion of the advert. The interactive section includes a question based on the advertisement that is being displayed and a set of possible answers to that question. The advert is not interrupted by the display of the interactive section and continues to play. The period before the interactive section is displayed may be defined for a particular advertisement, for example to fit with a particular scene in the advert, or may be displayed at a random period after the start of the advert.

The interactive section may be displayed in any location, but that location may be selected to maximise the impact of the section. For example, the answers could be spread over the display to increase the attention the user must pay to the advert to find the correct answer.

At step 22 the user selects one of the possible answers to the question, for example if the output device is a computer, the answer may be selected using a mouse.

At step 23 the answer selected by the user is checked to see if it is correct. This checking may be performed at the broadcast device after transmission of the selected answer to the broadcast device, or by the output device. In the latter case an indication as to whether the correct answer was chosen may be transmitted to the broadcast device from the output device.

If an incorrect answer is given to the question the advertisement continues to play at step 25. A temporary or permanent (for the duration of the advert) indication that the answer was incorrect may also be displayed, as may an indication of the correct answer. After a defined period the interactive section may be removed and the advert plays to the end, the section may remain displayed while the advert concludes, or the section may be removed immediately after the incorrect answer.

If the answer was correct at step 23 the advert skips to its end at step 24 and the program requested by the user is output. By giving a correct answer to the question the user has thus shortened the duration of the advert, thereby gaining an improved user experience and greater ability to control the media they are viewing. The advert may not skip directly to the end but a shortened or alternative version may be displayed.

The method shown in FIG. 2 is effective to improve users' experiences while also retaining exposure of advertisements. Although the duration of adverts can be reduced, this only occurs where the user demonstrates that they have paid attention to the advert, or have some knowledge of the product, by giving the correct answer to the question. The advert has therefore been effective at alerting the user to the subject of the advertisement. A trade-off is thereby achieved such that in return for greater attention to the advert, the user gains the ability to shorten the time they must observe the advert for.

A range of questions may be related to each advertisement such that users are not always presented with the same question and are forced to pay attention on each visit, or the same question and answer may be used each time a particular advert is seen by a user such that on subsequent views the advertisement can be skipped more quickly. In the above example the question was based on the content of the advertisement, but the questions may be based on any aspect of the product being advertised or the general marketing message that the advert intends to convey.

In a further modification of the method described above, after an incorrect answer is given the same or a different question may be asked again to give a second opportunity to the viewer to answer correctly and shorten the advert.

Data may be collected during the process relating to the behaviour of users viewing and interacting with the advert. This data may be simple metrics, for example time spent viewing the advert before answering, or may include identification data to identify particular users and their behaviour. The data may be utilised to control charging by the content provider. Adverts displayed using the system may be charged according to a mixed Cost Per Engagement (CPE) and Cost Per impression (CPM) model. For example, broadcasts where the user does not interact with the advert may be charged on the CPM model and broadcasts where the user does interact may be charged on a CPE model. The charging structure may also be modified dependent on whether the user answered the question correctly or incorrectly.

The answers provided by users may be utilised to monitor the effectiveness of advertising campaigns in real-time. For example, if a high proportion of users are getting questions wrong it may indicate the message is not getting across to users and revision is required. Such monitoring may be provided by transmitting information about a user's selections to a monitoring system.

Control over the media may be provided at the broadcast device, or at the output device, depending on the particular distribution being utilised. In the case of downloadable media, where at least a portion of the media is stored on the output device for playback, the control may be most efficiently provided at the output device. For example, the media may include additional computer executable code which displays the interactive section and causes the playback to skip to a specified location in the downloaded media when a correct answer is given. In the case of ‘streamed’ broadcast services where the media is displayed directly on receipt from the broadcast data, the control may be most efficiently provided at the broadcast device. The output device may transmit an indication of the answer, or its correctness, and the broadcast device responds by broadcasting the appropriate media; in the case of an incorrect answer the advert would continue to be broadcast, but if an indication of a correct answer is received the broadcast would skip to the program, a defined point in the advert, or an alternative advert could be broadcast.

The questions and interactive section may be stored as part of the media data or may be stored as separate data for combination with the media data at an appropriate time before or during broadcast.

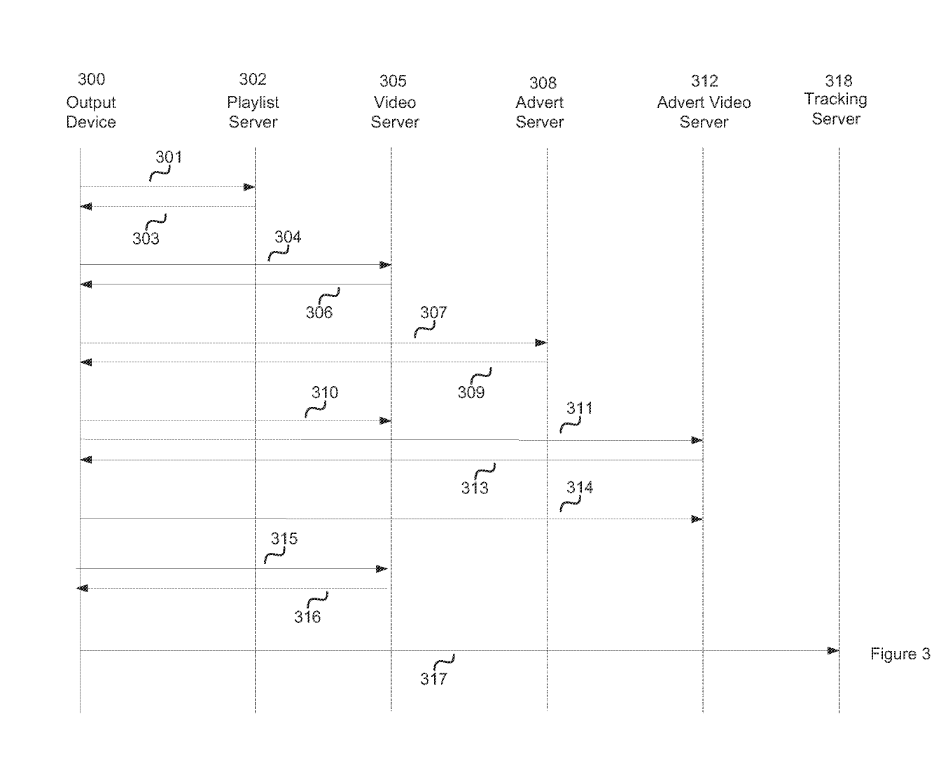

The above description has provided an overview of the operation of the method, but as will be appreciated there are many possible modes of implementation. For example, the broadcast device may be a single device, or may comprise a plurality of different devices, each providing parts of the information content, interactive section and functionality. FIG. 3 shows an interaction diagram of a specific implementation in which a number of different server systems are utilised.

In response to commands from a user an output device 300 requests 301 a playlist from the playlist server 302. The playlist server 302 returns 303 the playlist to the output device 300. The playlist contains address and timing information for the content to be displayed by the output device, for example in an XML format.

A request 304 is sent to the video server 305 as indicated in the playlist and the video data is streamed 306 to the output device 300 and displayed. When the playback approaches a time indicated in the playlist to display an advert and interactive section a request 307 is sent to an advert server 308 which transmits 309 data relating to the advert and the interactive section to the output device 300. A pause instruction 310 is sent to the video server and a request 311 is sent to an advert video server 312 which responds by streaming 313 the advert to the output device 300.

The output device displays the advert and the interactive section and operates as described previously—the interactive section is displayed and the user selects an answer. The output device utilises the data received from the advert server 308 to determine if the question has been answered correctly. If the correct answer is given, the output device 300 sends a stop request 314 to the advert video server to terminate the advert stream and sends a continue request 315 to the video server 305 to restart streaming 316 of the paused video stream. By answering the question correctly, the user has thereby shortened the duration of the advert.

If the incorrect answer was given the output device continues to display the streamed advert video to the end and stop request 314 is not issued. At the end of the advert the continue request 315 is sent to the video server 305 to restart streaming 316 of the paused video stream.

Information related to the user's interaction (for example, the answer provided and timing information) with the advert may be transmitted 317 to a tracking server 318 to monitor views of the advert for performance or charging monitoring.

As will be appreciated the timings and signals shown in FIG. 3 are provided as an example only and variations may be utilised as appropriate to particular situations. For example, the stop 314 and continue 315 requests may be sent simultaneously, or in the reverse order to that indicated to ensure a seamless switch from the advert to the video.

In an alternative implementation the pause 310 and continue 315 requests may be omitted and while the advert is being streamed the video stream may continue and be buffered by the output device.

As has been mentioned previously, the decision as to the correctness of the answer may be taken by a device remote from the output device 300, for example the tracking server 318 or the advert server 308 may be utilised. In such an implementation the answer given by the user is transmitted to the selected server, a decision taken, and then a signal sent to the output device to indicate if the answer was correct or not. The output device then issues the appropriate requests. Similarly, any of the servers, or other devices, may be utilised to decide upon whether the answer was correct.

As will be appreciated, the order in which the sections is displayed may be varied, for example the advert may be the first section displayed, rather than initially playing the requested video. Such variations are easily achieved by modifying the order in which the requests shown in FIG. 3 are sent and performed.

In the example of FIG. 3 a correct answer caused the advert to be stopped, but in an alternative implementation a request for an alternative section may be transmitted and streaming and display of that section performed. For example, the alternative section may be shorter.

In the above example the video stream is a continuous stream into which adverts are inserted by the output device. In alternative implementations, the video may be provided as a number of individual streams, each corresponding to a section between adverts. The playlist would indicate the location, order and timings of the streams to display them as a continuous output. Other alternatives are also possible, for example the video and adverts may be provided as a single stream.

The various components of the system used in relation to FIG. 3 are provided as an example only, and other combinations may be utilised without departing from the principles underlying the present description. For example, the advert video server 312 and video server 305 may be a single device.

The above specific example relates to the shortening of an advert, but the same principles may be applied by selecting content based on the answer given by the user. For example, specific content may be selected to inform the user of aspects they have answered incorrectly about.

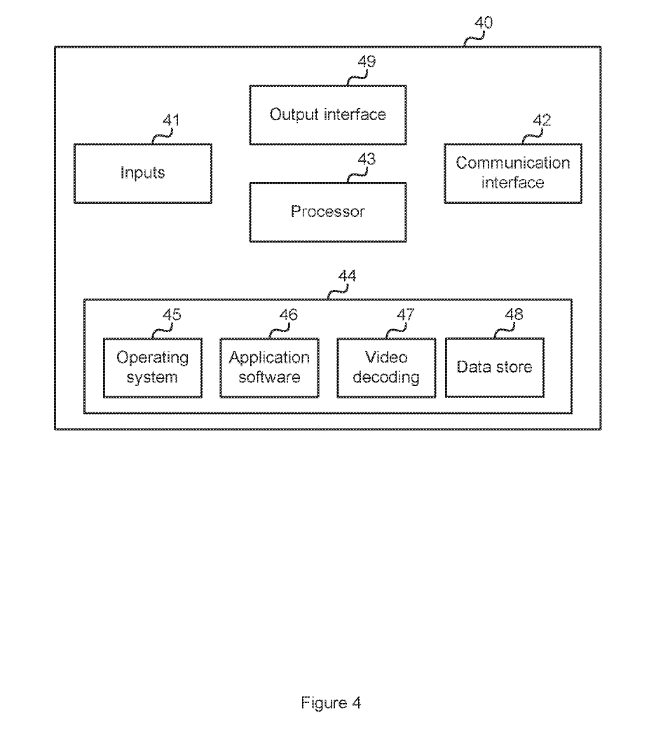

FIG. 4 illustrates various components of an exemplary output device 13 in an example where the output device 13 is provided by a computing-based device 40 which may be implemented as any form of a computing and/or electronic device.

The computing-based device 40 comprises one or more inputs 31 which are of any suitable type for receiving media content, Internet Protocol (IP) input, 2D or higher dimensional digital images including moving images such as videos, generated or captured moving images. The device also comprises communication interface 42 to enable the device to connect to a communications network and communicate with other entities on the network.

Computing-based device 40 also comprises one or more processors 43 which may be microprocessors, controllers or any other suitable type of processors for computing executable instructions to control the operation of the device in order to carry out decoding of the received data and display of media. Platform software 44 comprising an operating system 45 or any other suitable platform software may be provided at the computing-based device to enable application software 46 to be executed on the device. The application software 46 can comprise such components as a video decoding engine 47.

The computer executable instructions may be provided using any computer-readable media, such as memory 48. The memory is of any suitable type such as random access memory (RAM), a disk storage device of any type such as a magnetic or optical storage device, a hard disk drive, or a CD, DVD or other disc drive. Flash memory, EPROM or EEPROM may also be used.

An output is also provided such as an audio and/or video output to a display interface 49 integral with or in communication with the computing-based device. The display interface may provide a graphical user interface, or other user interface of any suitable type, although this is not essential.

Any range or device value given herein may be extended or altered without losing the effect sought as will be apparent to the skilled person.

It will be understood that the benefits and advantages described above may relate to one embodiment or may relate to several embodiments. The embodiments are not limited to those that solve any or all of the stated problems or those that have any or all of the stated benefits and advantages.

Any reference to ‘an’ item refers to one or more of those items. The term ‘comprising’ is used herein to mean including the method blocks or elements identified, but that such blocks or elements do not comprise an exclusive list and a method or apparatus may contain additional blocks or elements.

The steps of the methods described herein may be carried out in any suitable order, or simultaneously where appropriate. Additionally, individual blocks may be deleted from any of the methods without departing from the spirit and scope of the subject matter described herein. Aspects of any of the examples described above may be combined with aspects of any of the other examples described to form further examples without losing the effect sought. The method blocks or elements identified do not comprise an exclusive list and a method or apparatus may contain additional blocks or elements.

It will be understood that the above description of a preferred embodiment is given by way of example only and that various modifications may be made by those skilled in the art. Although various embodiments have been described above with a certain degree of particularity, or with reference to one or more individual embodiments, those skilled in the art could make numerous alterations to the disclosed embodiments without departing from the spirit or scope of this invention.

The term ‘comprising’ is used herein to mean including.

The term ‘computer’ is used herein to refer to any device with processing capability such that it can execute instructions. Those skilled in the art will realize that such processing capabilities are incorporated into many different devices and therefore the term ‘computer’ includes PCs, servers, mobile telephones, personal digital assistants and many other devices.

The methods described herein may be performed by software in machine readable form on a tangible storage medium. The software can be suitable for execution on a parallel processor or a serial processor such that the method steps may be carried out in any suitable order, or simultaneously.

This acknowledges that software can be a valuable, separately tradable commodity. It is intended to encompass software, which runs on or controls “dumb” or standard hardware, to carry out the desired functions. It is also intended to encompass software which “describes” or defines the configuration of hardware, such as HDL (hardware description language) software, as is used for designing silicon chips, or for configuring universal programmable chips, to carry out desired functions.

Those skilled in the art will realize that storage devices utilized to store program instructions can be distributed across a network. For example, a remote computer may store an example of the process described as software. A local or terminal computer may access the remote computer and download a part or all of the software to run the program. Alternatively, the local computer may download pieces of the software as needed, or execute some software instructions at the local terminal and some at the remote computer (or computer network). Those skilled in the art will also realize that by utilizing conventional techniques known to those skilled in the art that all, or a portion of the software instructions may be carried out by a dedicated circuit, such as a DSP, programmable logic array, or the like.

What is claimed is:

1. A method of displaying customised media content, comprising:
receiving video data, including an advertisement, at an output device;
displaying the advertisement on the output device;
receiving interactive data, including a question, a correct answer to the question and at least one incorrect answer to the question, at the output device;
displaying the question, the correct answer and the incorrect answer on the output device;
receiving an indication of a user's answer to the question at the output device; and
displaying further visual content on the output device based on the answer.

2. The method according to claim 1, wherein the video data is a streamed video received from a video content server over a network.

3. The method according to claim 1, wherein the user's answer is incorrect and the further visual content is the remainder of the video.

4. The method according to claim 1, wherein the user's answer is correct and the further visual content is visual content requested by the user which is displayed earlier than would have occurred if the user's answer had been incorrect.

5. The method according to claim 1, wherein the user's answer is transmitted to a remote device to determine whether the answer is correct.

6. The method according to claim 1, wherein the video and/or interactive data is transmitted to the output device as a self-contained file for later playback.

7. The method according to claim 1, wherein the user's answer is transmitted to a remote device for monitoring of answers provided by users.

8. A method of transmitting customisable media content to an output device, comprising:
streaming video data, including an advertisement, to an output device;
transmitting, to the output device, interactive data including a question, a correct answer to the question and at least one incorrect answer to the question;
receiving, from the output device, a request to terminate streaming of the video data before the end of the video data, and
receiving, from the output device, a request to stream different video data to the output device.

9. The method according to claim 8, wherein the request to terminate streaming of the video data is received from the output device in response to a user of the output device indicating a correct answer to the question.

10. The method according to claim 1, wherein the interactive section is displayed concurrently with the advertisement.

11. The method according to claim 10, wherein the interactive section is displayed alongside the advertisement.

12. The method according to claim 10, wherein the interactive section is displayed over at least a portion of the advertisement.

13. The method according to claim 1, wherein the advertisement is displayed for a predetermined period of time before the interactive section is displayed.

14. The method according to claim 1, further comprising:
receiving video data, including visual content requested by the output device, at the output device; and
displaying the visual content on the output device for a predetermined period of time before displaying the advertisement on the output device.
